(19) United States
(12) Patent Application Publication
(10) Pub. No.: US 2011/0293240 A1
(43) Pub. Date: Dec. 1, 2011

(54) METHOD AND SYSTEM FOR TRANSMITTING OVER A VIDEO INTERFACE AND FOR COMPOSITING 3D VIDEO AND 3D OVERLAYS

(75) Inventors: Philip Steven Newton, Eindhoven (NL); Mark Josef Maria Kurvers, Eindhoven (NL); Dennis Daniël Robert Josef Bolio, Eindhoven (NL)

(73) Assignee: KONINKLIJKE PHILIPS ELECTRONICS N.V., EINDHOVEN (NL)

(21) Appl. No.: 13/145,187

(22) PCT Filed: Jan. 13, 2010
(86) PCT No.: PCT/IB2010/050125

§ 371 Date: Jul. 22, 2011

(30) Foreign Application Priority Data
Jan. 20, 2009 (EP) 09150947.1

(51) Int. Cl. H04N 5/775; H04N 13/00

(52) U.S. Cl. 386/230; 348/43; 348/E13.044; 386/E05.07

(57) ABSTRACT

A system of transferring of three dimensional (3D) image data for compositing and displaying is described. The information stream comprising video information and overlay information, the video information comprising at least a 2D video stream and 3D video information for enabling rendering of the video information in 3D, the overlay information comprising at least a 2D overlay stream and 3D overlay information for enabling rendering of the overlay information in 3D. In the system according to the invention, the compositing of video plane takes place in the display device instead of the playback device. The system comprises a playback device adapted for transmitting over the video interface a sequence of frames, the sequence of frames comprising units, each unit corresponding to decompressed video information and decompressed overlay information intended to be composited and displayed as a 3D image, and a display device adapted for receiving over the video interface the sequence of frames and extracting the 3D video information and the 3D overlay information from the units and compositing the units into 3D frames and displaying the 3D frames.

### FIELD OF THE INVENTION

The present invention relates to a method of compositing and displaying an information stream comprising video information and overlay information, the video information comprising at least a 2D video stream and 3D video information for enabling rendering of the video information in 3D, the overlay information comprising at least a 2D overlay stream and 3D overlay information for enabling rendering of the overlay information in 3D, the transmitted video information and overlay information being composited and displayed as a 3D video.

The present invention also relates to a system for of compositing and displaying an information stream comprising video information and overlay information, the video information comprising at least a 2D video stream and 3D video information for enabling rendering of the video information in 3D, the overlay information comprising at least a 2D overlay stream and 3D overlay information for enabling rendering of the overlay information in 3D, the transmitted video information and overlay information being composited and displayed as a 3D video.

The present invention also relates to a playback device and to a display device, each suitable to be used in above-mentioned system.

The invention relates to the field of transferring, via a high-speed digital interface, e.g. HDMI, three-dimensional image data, e.g. 3D video, for display on a 3D display device.

### BACKGROUND OF THE INVENTION

Present video players facilitate compositing of multiple layers of video and/or graphics. For example, in the Blu-ray Disc platform there can be a secondary video playing on top of the primary video (for instance for director comments). On top of that there can be graphics, such as subtitles and/or menus. These different layers are all decoded/drawn independently, and at a certain point are composited to a single output frame.

This process is relatively straightforward to implement in the case of for 2D display; every non-transparent pixel of a layer that is in front of another layer occludes the pixel of the layer behind it. This process is depicted in FIG. 3 which is a top-down view of a scene. The direction of the Z-axis is shown 301. The video layer 302 in the scene is fully green, and there is a blue object drawn on the graphics layer 303 (the rest is transparent). After the compositing step 305, the blue object is drawn over the green video layer as the graphics layer is in front of the video layer. The results in a composited layer as output 304.

The process is relatively straightforward to implement because there is only 1 viewpoint when displaying the scene in 2D. However, when the scene is displayed in 3D there are multiple viewpoints (at least 1 viewpoint for each eye, possibly more viewpoints when using multi-view displays). The problem is that because the graphics layer is in front of the video layer, other parts of the video layer are visible from different viewpoints. This problem is depicted in FIG. 4.

It is noted that 3D compositing is fundamentally different from 2D composition. In 2D compositing, as it is illustrated for example in US 2008/0158250, multiple 2D planes (e.g. main video, graphics, interactive plane) are composited by associating a depth to each plane. However, the depth parameter in 2D compositing only determines the order in which pixels from different planes are composited, i.e. which plane has to be drawn on top, without the final image being suitable for three dimensional display. Such 2D compositing is always be done pixel by pixel.

In contrast, when composition 3D planes, the composition is non-local. When objects from each plane is three dimensional, it is possible that object from a lower plane protrude through a higher plane, or that objects from a higher plane fall bellow the lower plane. Moreover, in side views, it is possible to see behind object, so if in a view a pixel may correspond to an object from the front plane, while in another view the equivalent pixel correspond to an object from a lower plane.

FIG. 4 shows again a top-down view of a scene consisting of two layers. The direction of the Z-axis 401 is given. The video layer 402 is fully green and the graphics layer 403, which is in front of the video layer, has a blue object on it (and the rest of it is transparent). Now two possible viewpoints are defined 404, 405. As is shown by the picture, from one viewpoint 404 different parts of the video layer are visible 406 than are visible 407 from the other viewpoint 405. This means that a device that is rendering the two views should have access to all information from both layers (else the device is missing information to render at least one of the views).

In the current situation, a system for playback of 3D video comprise a 3d player, which is responsible for decoding compressed video stream for the various layer, compositing the various layers and sending the decompressed video over a video interface, such as HDMI or VESA, to the display, usually a 3D TV (stereo or autostereoscopic). The display device renders the views, meaning that indeed it will miss information to do a perfect rendering of the two views (which inherently is also a problem when rendering more than two views).

### SUMMARY OF THE INVENTION

It is an object of the invention to provide a method of compositing an information stream comprising video information and overlay information such that the rendering of views is improved. The object of the invention is reached by a method according to claim 1. In the method according to the invention, wherein the video information comprising at least a 2D video stream and 3D video information for enabling rendering of the video information in 3D, the overlay information comprising at least a 2D overlay stream and 3D overlay information for enabling rendering of the overlay information in 3D, the method comprising receiving or reading from a storage medium a compressed stream comprising compressed video information and compressed overlay information; decompressing the video information and the overlay information; transmitting over the video interface a sequence of frames, the sequence of frames comprising units, each unit corresponding to decompressed video information and decompressed overlay information intended to be composited and displayed as a 3D image; receiving over the video interface the sequence of frames and extracting the 3D video information and the 3D overlay information from the units; compositing the units into 3D frames and displaying the 3D frames. The method according to the invention breaks apart the present approach where decoding and compositing is done by the player device and the rendering by the display device. This is based on the insight that to overcome the problem of missing information while rendering one of the viewpoints, all visual information from the video layer and all visual information from the graphics layers should be available at the place where the rendering is done.

Furthermore, in an autostereoscopic display, the format and layout of the sub-pixels differs per display type also the alignment between the lenticular lenses and the sub-pixels of the panel differs somewhat for every display. Therefore it is advantageous that the rendering is done in the multiview display instead of in the player as the accuracy of alignment of the sub-pixels in the rendered views with the lenticular lenses would be far less accurate than what can be achieved in the display itself. Additionally, if the rendering is done in the display it allows the display to adjust the rendering to the viewing conditions, amount of depth preference of the user, size of the display (important, the amount of depth perceived by the end user depends on display size), distance of the viewer to the display. These parameters are normally not available in the playback device. Preferably, all information from the video layer and all information from the graphics layers should be sent as separate components to the display. This way, there is no missing information from the video layer when rending one of the views, and a high quality rendering from multiple viewpoints can be made.

In an embodiment of the invention, the 3D video information comprises depth, occlusion and transparency information with respect to 2D video frames, and the 3D overlay information comprises depth, occlusion and transparency information with respect to 2D overlay frames.

In a further an embodiment of the invention, wherein the overlay information comprises two graphics planes to be composited with the video frames. Advantageously, more layers could be sent to the display (background, primary video, secondary video, presentation graphics, interactive graphics). In the Blu-ray Disc platform, it is possible to have multiple layers occluding each other. For example, the interactive graphics layer can occlude parts of the presentation graphics layer, which in turn can occlude parts of the video layer. From different viewing points, different parts of each layer can be visible (in the same way as it works with just two layers). Therefore, the quality of the rendering could be improved in certain situations by sending more than two layers to the display.

In a further an embodiment of the invention, the overlay information for at least one graphic plane being sent at a lower frame frequency that a frames frequency at which the 2D video frames are sent. Sending all information necessary for compositing each 3D frame is burdensome for the interface This embodiment is based on the insight that most overlay plane do not comprise fast moving object, but mostly static objects such as menus and subtitles, hence they can be sent at a lower frame frequency without a significant reduction in quality.

In a further an embodiment of the invention, the overlay information a pixel size of the overlay information for at least one graphic plane differs from a pixel size of the 2D video information. This is based on the insight that some planes can be scaled down without a significant loss of information, hence the burden on the interface reduced without a significant reduction in quality. In a more detailed embodiment, a pixel size of the 2D overlay information differs from a pixel size of the 3D overlay information (such as depth or transparency). This also reduces the burden on the interface without a significant reduction in quality.

This application also relates to a system for 3 compositing and displaying of video information and overlay information, the video information comprising at least a 2D video stream and 3D video information for enabling rendering of the video information in 3D, the overlay information comprising at least a 2D overlay stream and 3D overlay information for enabling rendering of the overlay information in 3D, the system comprising a playback device for receiving or reading from a storage medium a compressed stream comprising compressed video information and compressed overlay information; decompressing the video information and the overlay information; transmitting over the video interface a sequence of frames, the sequence of frames comprising units, each unit corresponding to decompressed video information and a display device for receiving over the video interface the sequence of frames and extracting the 3D video information and the 3D overlay information from the units and compositing the units into 3D frames and displaying the 3D frames.

### BRIEF DESCRIPTION OF THE DRAWINGS

The features and advantages of the invention will be further explained upon reference to the following drawings, in which:

FIG. 1 shows schematically a system 1 for playback of 3D video information wherein the invention may be practiced

FIG. 2 shows schematically a known graphic processing unit

FIG. 3 shows a top view of the compositing of a scene that consists of two layers

FIG. 4 shows a top view of a scene consisting of two layers, with two viewpoints defined

FIG. 5 shows video and graphics planes composited for the mono (2D) situation

FIG. 6 shows planes for stereo 3D

FIG. 7 shows planes for image+depth 3D

FIG. 8 shows planes for image+depth 3D

FIG. 9 shows schematically units of frames to be sent over the video interface, according to an embodiment of the invention

FIG. 10 shows schematically further details of units of frames to be sent over the video interface, according to an embodiment of the invention

FIG. 11 shows schematically the time output of frames over the video interface, according to an embodiment of the invention

FIG. 12 shows schematically a processing unit and an output stage according to an embodiment of the invention

FIG. 13 shows schematically a processing unit and an output stage according to an embodiment of the invention

FIG. 14 shows schematically the time output of frames over the video interface, according to an embodiment of the invention

FIG. 15 shows schematically shows schematically the time output of frames over the video interface, according to an embodiment of the invention

FIG. 16 shows schematically a processing unit and an output stage according to an embodiment of the invention.

### DETAILED DESCRIPTION OF THE PREFERRED EMBODIMENTS

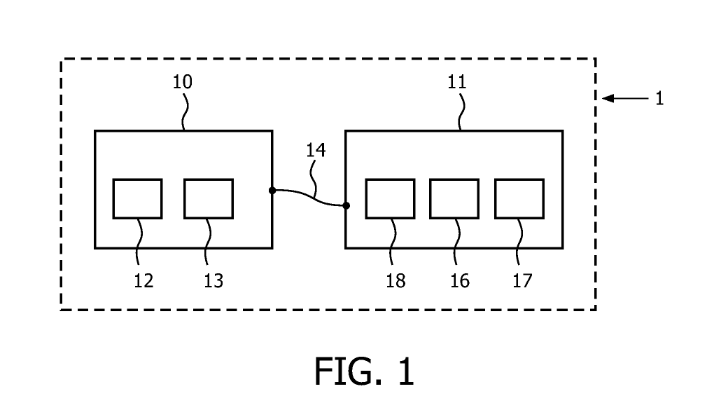

A system 1 for playback and displaying of 3D video information wherein the invention may be practiced is shown in FIG. 1. The system comprises a player device 10 and a display device 11 communicating via an interface 12. The player device 10 comprises a front end unit 12 responsible for receiving and pre-processing the coded video information stream to be displayed, and a processing unit 13 for decoding, processing and generation a video stream to be supplied to the output 14. The display device comprises a rendering unit for rendering 3D views from the received.

With respect to the coded video information stream, for example this may under the format known as stereoscopic, where left and right (L+R) images are encoded. Alternatively, coded video information stream may comprise a 2D picture and an additional picture (L+D), a so-called depth map, as described in Oliver Sheer—“3D Video Communication”, Wiley, 2005, pages 29-34. The depth map conveys information about the depth of objects in the 2D image. The grey scale values in the depth map indicate the depth of the associated pixel in the 2D image. A stereo display can calculate the additional view required for stereo by using the depth value from the depth map and by calculating the required pixel transformation. The 2D video+depth map may be extended by adding occlusion and transparency information (DOT). In a preferred embodiment, a flexible data format comprising stereo information and depth map, adding occlusion and transparency, as described in EP 08305420.5 (Attorney docket PH010082), to be included herein by reference, is used.

With respect to the display device 11, this can be either a display device that makes use of controllable glasses to control the images displayed to the left and right eye respectively, or, in a preferred embodiment, the so called autostereoscopic displays are used. A number of auto-stereoscopic devices that are able to switch between 2D and 3 D displays are known, one of them being described in U.S. Pat. No. 6,069,650. The display device comprises an LCD display comprising actively switchable Liquid Crystal lenticular lens. In auto-stereoscopic displays processing inside a rendering unit 16 converts the decoded video information received via the interface 12 from the player device 10 to multiple views and maps these onto the sub-pixels of the display panel 17.

With respect to the player device 10, this may be adapted to read the video stream from an optical disc, by including an optical disc unit for retrieving various types of image information from an optical record carrier like a DVD or BluRay disc. Alternatively, the input unit may include a network interface unit for coupling to a network, for example the internet or a broadcast network. Image data may be retrieved from a remote media server. Alternatively, the input unit may include an interface to other types of storage media, such as solid state memory.

A known example of a Blu-Ray™ player is the PlayStation™ 3, as sold by Sony Corporation.

In case of BD systems, further details, including the compositing of video planes, can be found in the publicly available technical white papers “Blu-ray Disc Format General August 2004” and “Blu-ray Disc 1.C Physical Format Specifications for BD-ROM November, 2005”, published by the Blu-Ray Disc association (http://www.bluraydisc.com).

In the following, when referring to the details of the BD application format, we refer specifically to the application formats as disclosed in the US application No. 2006-0110111 (Attorney docket NL021359) and in white paper “Blu-ray Disc Format 2.B Audio Visual Application Format Specifications for BD-ROM, March 2005” as published by the Blu-ray Disc Association.

It is known that BD systems also provide a fully programmable application environment with network connectivity thereby enabling the Content Provider to create interactive content. This mode is based on the Java™( )3 platform and is known as “BD-J”. BD-J defines a subset of the Digital Video Broadcasting (DVB)-Multimedia Home Platform (MHP) Specification 1.0, publicly available as ETSI TS 101 812.

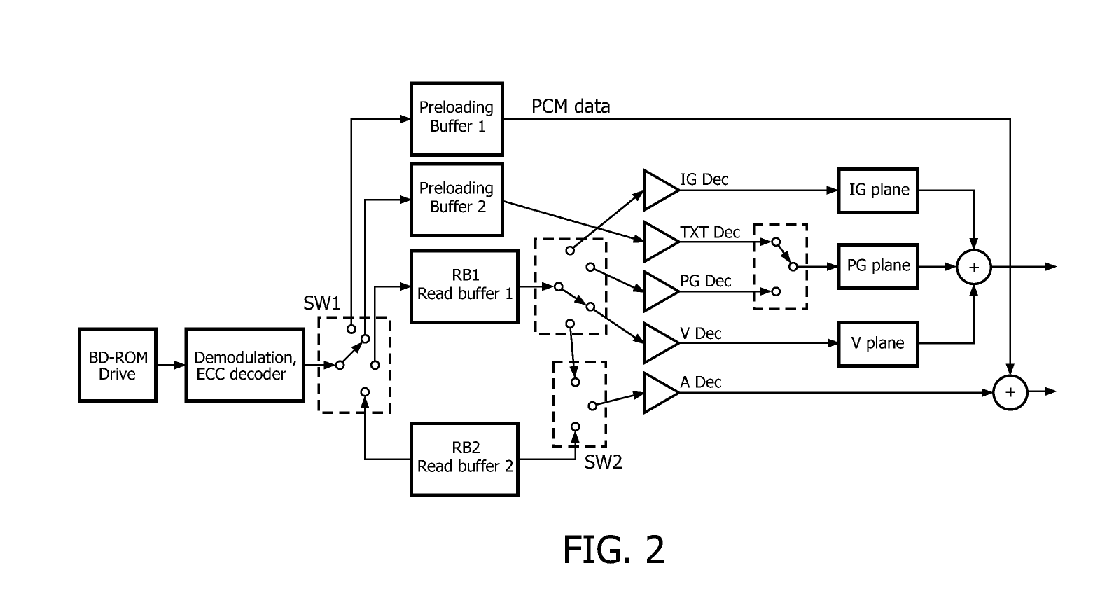

FIG. 2 illustrates a graphics processing unit (part of the processing unit 13) of a known 2D video player, namely a Blu-Ray player. The graphics processing unit is equipped with two read buffers (1304 and 1305), two preloading buffers (1302 and 1303) and two switches (1306 and 1307). The second read buffer (1305) enables the supply of an Out-of-Mux audio stream to the decoder even while the main MPEG stream is being decoded. The preloading buffers cache Text subtitles, Interactive Graphics and sounds effects (which are presented at Button selection or activation). The preloading buffer 1303 stores data before movie playback begins and supplies data for presentation even while the main MPEG stream is being decoded.

The switch 1301 between the data input and buffers selects the appropriate buffer to receive packet data from any one of read buffers or preloading buffers. Before starting the main movie presentation, effect sounds data (if it exists), text subtitle data (if it exists) and Interactive Graphics (if preloaded Interactive Graphics exist) are preloaded and sent to each buffer respectively through the switch. The main MPEG stream is sent to the primary read buffer (1304) and the Out-of-Mux stream is sent to the secondary read buffer (1305) by the switch 1301. The main video plane (1310) and the presentation (1309) and graphics plane (1308) are supplied by the corresponding decoders, and the three planes are overlayed by an overlayer 1311 and outputted.

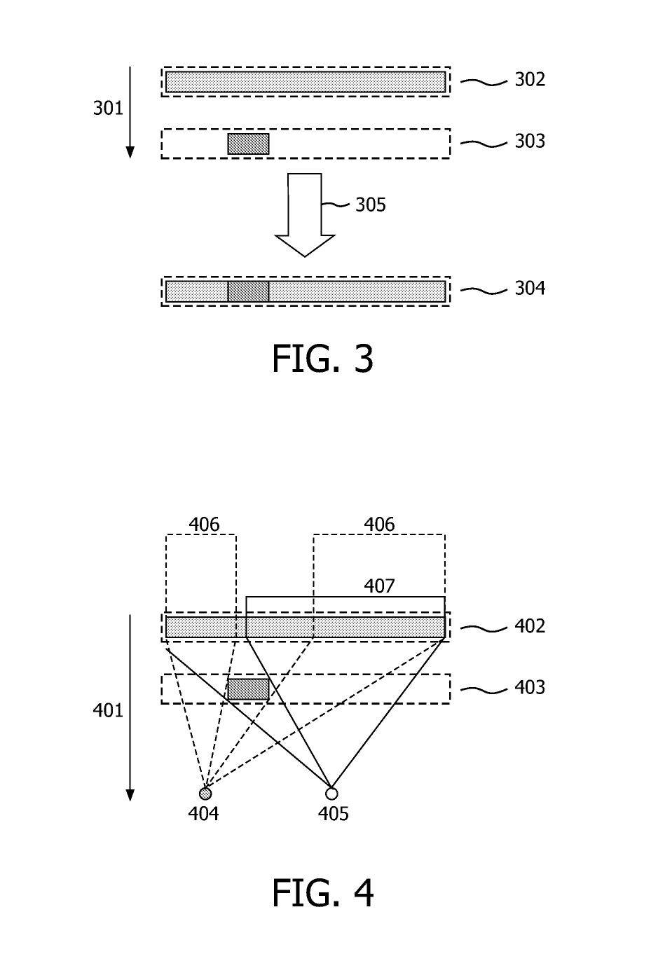

According to the invention, the compositing of video plane takes place in the display device instead of the playback device, by introducing a compositing stage 18 in the display device and adapting accordingly the processing unit 13 and the output 14 of the player device. The detailed embodiments of the invention with be described with reference to FIGS. 3 to 15.

According to the invention the rendering is done in the display device, hence all information from multiple layers must be sent to the display. Only then can a rendering be made from any viewpoint, without having to estimate certain pixels.

There are multiple ways of sending multiple layers separately to the rendering device (display). If we assume a video at 1920×1080 resolution with a frame rate of 24 fps, one way would be to increase the resolution of the video sent to the rendering device. For instance, increasing the resolution to 3840×1080 or to 1920×2160 allows sending both the video layer and the graphics layer separately to the rendering device in this example, it would be respectively side-by-side and top-bottom). HDMI and display port have enough bandwidth to allow for this. Another option is increasing the frame rate. For instance, when video is sent to the display at 48 or 60 fps, two different layers could be sent to the rendering device time interleaved (at a certain moment the frame sent to the display contains just the data from the video layer, and at another moment the frame sent to the display contains just the data from the graphics layer). The rendering device should know how to interpret the data that it receives. To this end, a control signal could be sent to the display (for instance by using I2C).

FIG. 3 illustrates a top view of the compositing of a scene that consists of two layers wherein the numerals indicate
301: Direction of the Z-axis
302: Video layer
303: Graphics layer
304: Composited layer (output)
305: Compositing action.

FIG. 4, illustrates a top view of a scene consisting of two layers, with two viewpoints defined, wherein the numerals indicate
401: Direction of the Z-axis
402: Video layer
403: Graphics layer
404: Viewpoint 1 (i.e. left eye)
405: Viewpoint 2 (i.e. right eye)
406: Parts of the background layer needed from viewpoint 1
407: Parts of the background layer needed from viewpoint 2.

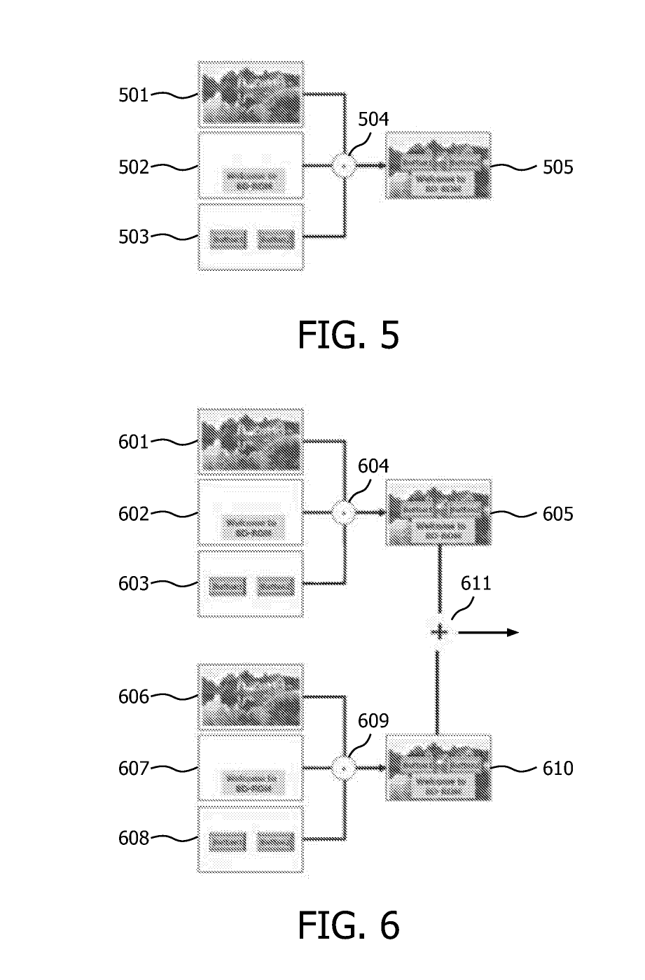

Players may have more than one graphics plane, e.g. separate planes (or layers) for subtitles and for interactive or Java generated graphics. This is depicted in FIG. 5. FIG. 5 shows the current state of planes compositing to the output. The input planes indicated by items 501, 502 and 503 are combined in 504 to create the output as shown in 505.

FIG. 5 illustrates BD video and graphics planes composited for the mono (2D) situation wherein the numerals indicate
501: Video plane
502: Presentation (subtitles) graphics plane
503: Java or Interactive graphics plane
504: Mixing and compositing stage
505: Output.

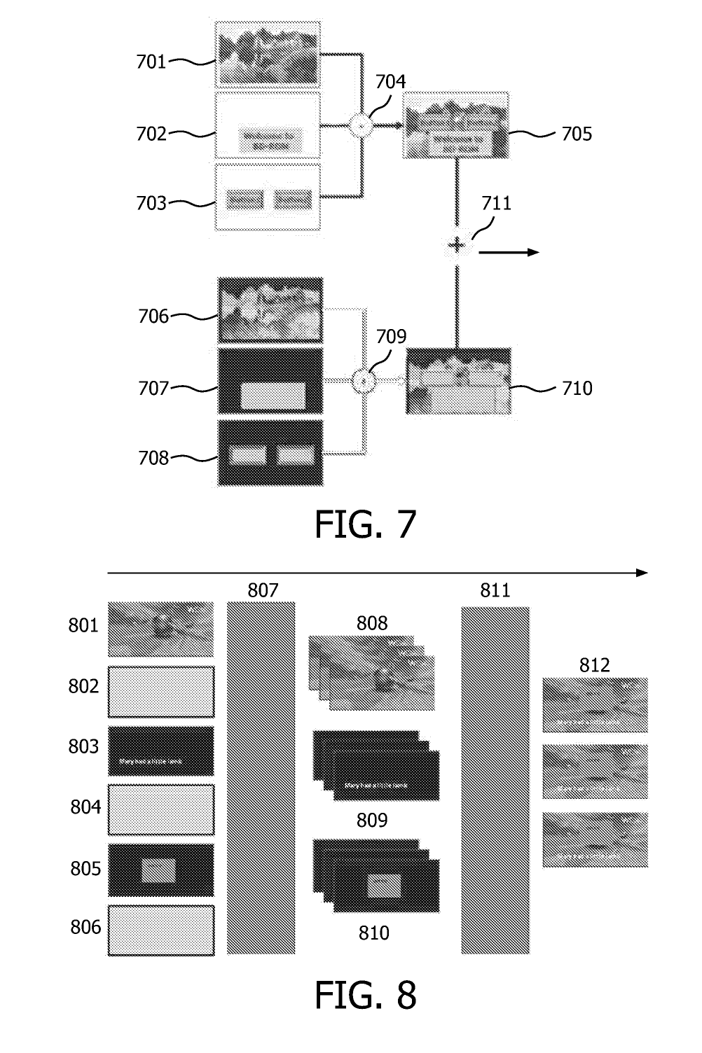

Advantageously for 3D, according to the invention, the planes are extended to also contain stereo and/or image+Depth graphics. The stereo case is shown in FIG. 6 and the image+Depth case is shown in FIG. 7.

FIG. 6 illustrates BD planes for stereo 3D, wherein the numerals indicate
601: Left Video plane
602: Left Presentation (subtitles) graphics plane
603: Left Java or Interactive graphics plane
604: Left Mixing and compositing stage
605: Left Output
606: Right Video plane
607: Right Presentation (subtitles) graphics plane
608: Right Java or Interactive graphics plane
609: Right Mixing and compositing stage
610: Right Output
611: Stereo Output.

FIG. 7 illustrates BD planes for image+depth 3D, wherein the numerals indicate
701: Video plane
702: Presentation (subtitles) graphics plane
703: Java or Interactive graphics plane
704: Mixing and compositing stage
705: Output
706: Depth Video plane
707: Depth Presentation (subtitles) graphics plane
708: Depth Java or Interactive graphics plane
709: Depth Mixing and compositing stage
710: Depth Output
711: image+depth output.

In the state of the art the planes are combined and then sent as one component or frame to the display. According to the invention the planes are not combined in the player but sent as separate components to the display. In the display the views for each component are rendered and then the corresponding views for the separate components are composited. The output is then shown on the 3D multiview display. This gives the best results without any loss in quality. This is shown in FIG. 8. Numbers 801 through 806 indicate the separate components sent over the video interface, they enter 807. In 807 each component is rendered into multiple views using its associated “depth” parameters component. These multiple view for all the video, subtitles and java graphics components are then composited in 811. The output of 811 is shown in 812 and this is then shown on the multiview display.

FIG. 8 illustrates video planes for image+depth 3D wherein the numerals indicate
801: Video component
802: Video Depth parameters component
803: Presentation (subtitles) graphics (PG) component
804: Presentation (subtitles) Depth parameters component
805: Java or Interactive graphics component
806: Java or Interactive graphics Depth component
807: Rendering stage that renders the Video, PG (subtitles) and Java or Interactive graphics to multiple views
808: Multiple video views
809: Multiple Presentation graphics (subtitles) views
810: Multiple Java or Interactive graphics views
811: Compositing stage
812: Multiple views that are shown on the display.

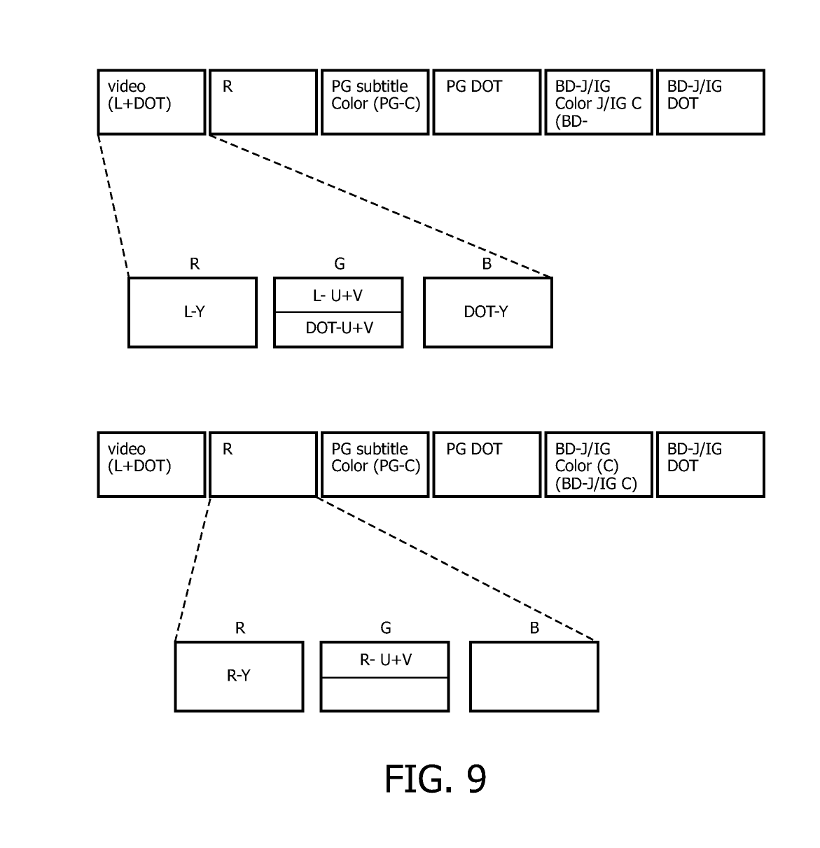

A preferred embodiment of the invention will be described with reference to FIGS. 9 to 11. According to the invention, the received compressed stream comprises 3D information that allows compositing and rendering on both stereoscopic and autostereoscopic display, i.e the compressed stream comprises a left and a right video frame, and depth (D), transparency (T) and occlusion (O) information for allowing rendering based on 2D+depth information. In the following depth (D), transparency (T) and occlusion (O) information will be shorthanded named as DOT.

The presence of both Stereo and DOT as compresses streams allows compositing and rendering that is optimized by the display, depending on the type and size of display while compositing is still controlled by the content author.

According to the preferred embodiment, the following components are transmitted over the display interface:
Decoded video data (not mixed with PG and IG/BD-J)
presentation graphics (PG) data
Interactive graphics (IG) or BD-Java generated (BD-J) Graphics data
Decoded Video DOT
presentation graphics (PG) DOT
Interactive graphics (IG) or BD-Java generated (BD-J) Graphics.

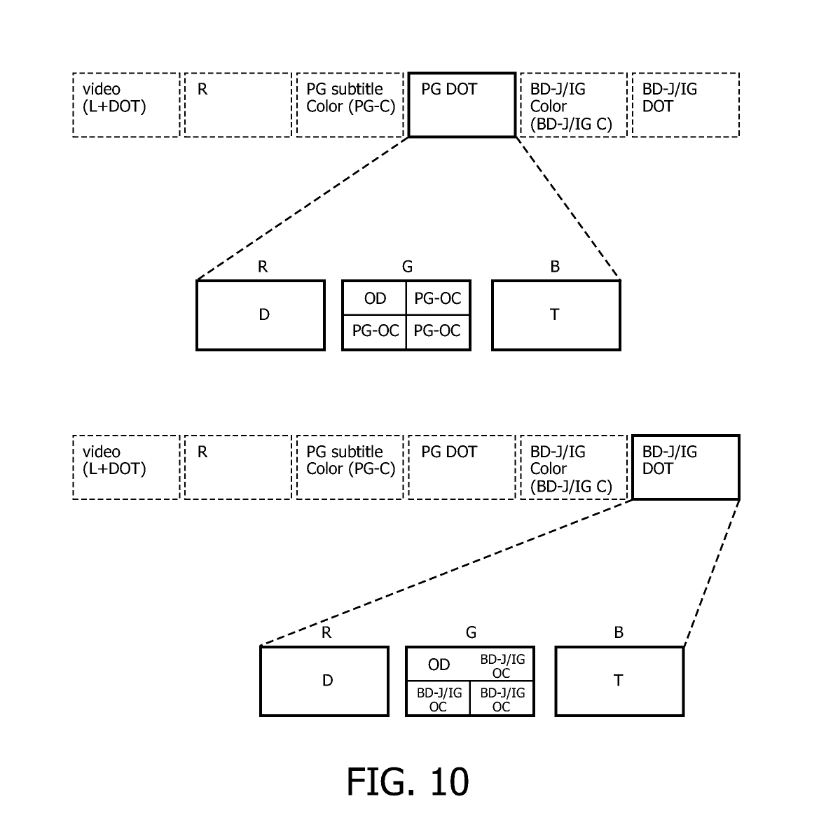

FIGS. 9 and 10 shows schematically units of frames to be sent over the video interface, according to an embodiment of the invention.

The Output stage sends over the interface (Preferably HDMI) units of 6 frames are sent.

Frame 1: The YUV components of the Left (L) video and DOT video are combined in one 24 Hz RGB output frame, components, as illustrated in the top drawing of FIG. 9. YUV designate as usual in the field of video processing the standard luminance (Y) and chroma (UV) components

Frame 2: The Right (R) video is sent unmodified out, preferably at 24 Hz as illustrated in the bottom drawing of FIG. 9

Frame 3: The PC color (PG-C) is sent unmodified out, as RGB components, preferably at 24 Hz.

Frame 4: The transparency of the PG-Color is copied into a separate graphics DOT output plane and combined with the depth and the 960×540 occlusion and occlusion depth (OD) components for various planes, as illustrated in the top drawing of FIG. 10.

Frame 5: The BD-J/IG color (C) is sent unmodified out preferably at 24 Hz.

Frame 6: The transparency of the BD-J/IG Color is copied into a separate graphics DOT output plane and combined with the depth and the 960×540 occlusion and occlusion depth (OD) components, as illustrated in the bottom drawing of FIG. 10.

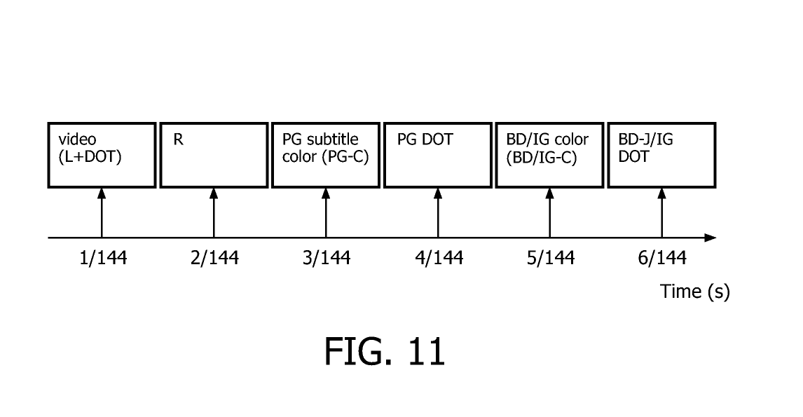

FIG. 11 shows schematically the time output of frames over the video interface, according to the preferred embodiment of the invention. Herein the components are sent at 24 Hz components interleaved in time over the HDMI interface at an interface frequency of 144 Hz to the display.

### Advantages of the Preferred Embodiment

The full resolution flexible 3D stereo+DOT format and 3D HDMI output allows enhanced 3D video (variable baseline for display size dependency) and enhanced 3D graphics (less graphics restrictions, 3D TV OSD) possibilities for various 3D displays (stereo and auto-stereoscopic)
No compromises to quality, authoring flexibility and with minimal cost to player hardware. Compositing and rendering is done in the 3D display.
The required higher video interface speed is being defined in HDMI for 4k2k formats and can already be implemented with dual-link HDMI. Dual link HDMI also supports higher frame rates such as 30 Hz etc.

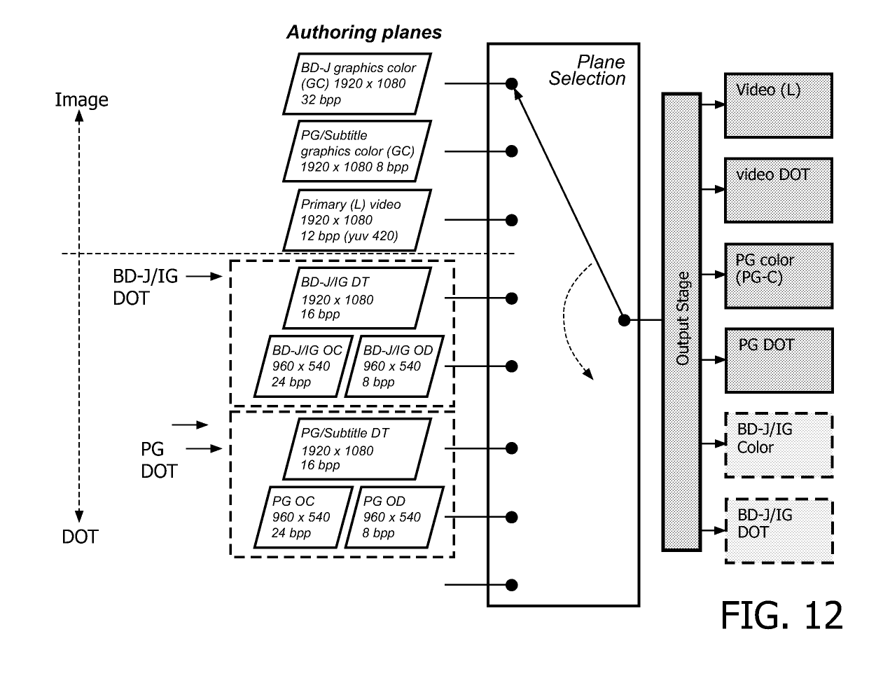

FIG. 12 shows schematically a processing unit (13) and an output stage 14) according to the preferred embodiment of the invention. The processing unit is adapted to process video and DOT separately for each plane of the invention. The outputs of each plane are selected at a proper time by a plane selection unit and sent to the output stage, which is responsible of generating the relevant frame to be sent over the interface.

The HDMI interface input of the display device is adapted to receive the units of frames as described above with respect to FIGS. 9 to 12, to separate them and sent the information to the compositing stage 18 which takes care of compositing of video planes. The output of the compositing stage is sent to the rendering unit for generating the rendered views.

It is acknowledged that the system according the preferred embodiment provides best 3D quality, but such system may be rather expensive. Hence a 2^{nd} embodiment of the invention addressed a lower cost system, which still provides a higher rendering quality than state of art systems.

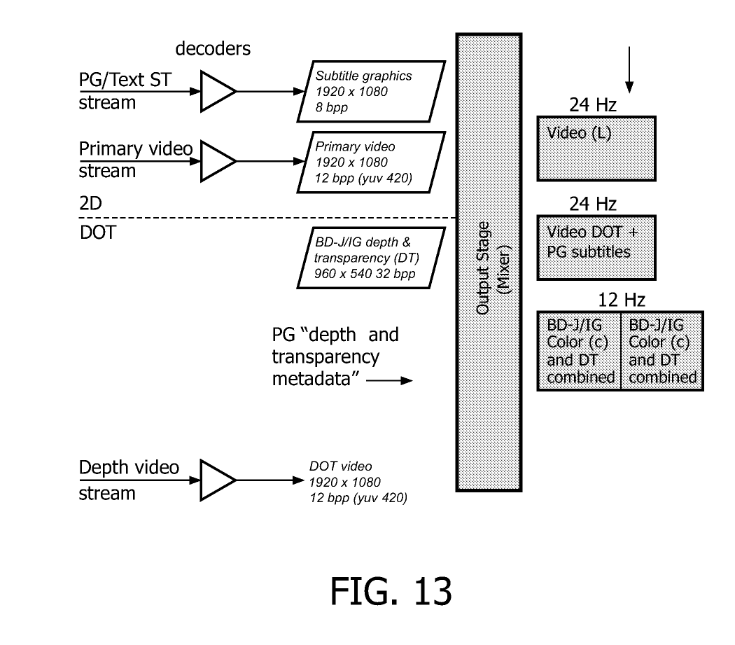

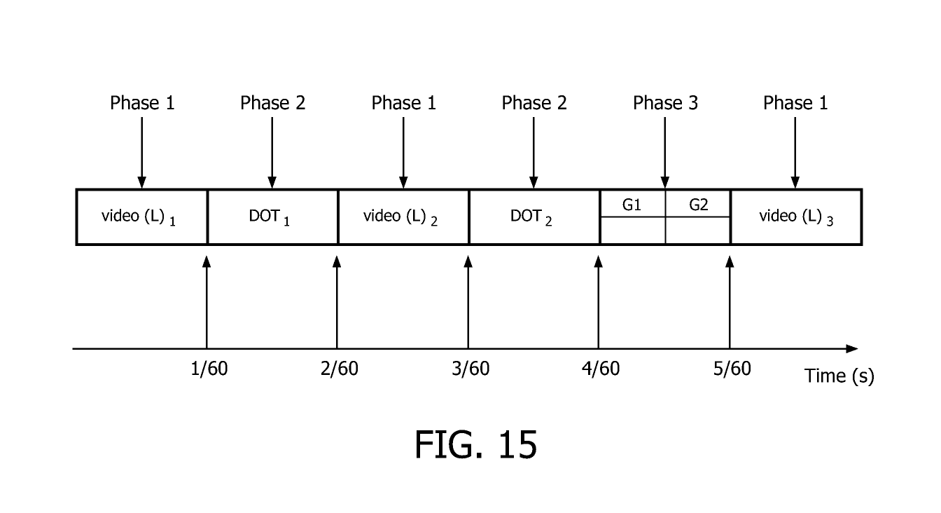

FIG. 13 shows schematically a processing unit and an output stage according to a 2^{nd} embodiment of the invention. The basic idea is to combine two time periods of Java graphics in one output frame period @12 Hz and interleave this with the video (L) @24 Hz and the combined video DOT and PG plane @24 Hz. Totaling the output to 1920×1080@60 Hz. FIG. 15 shows schematically shows schematically the time output of frames over the video interface, according to this embodiment of the invention.

The HDMI interface input of the display device according to this embodiment of the invention is adapted to receive the units of frames as described above with respect to FIGS. 13 and 15, to separate them and sent the information to the compositing stage 18 which takes care of compositing of video planes. The output of the compositing stage is sent to the rendering unit for generating the rendered views.

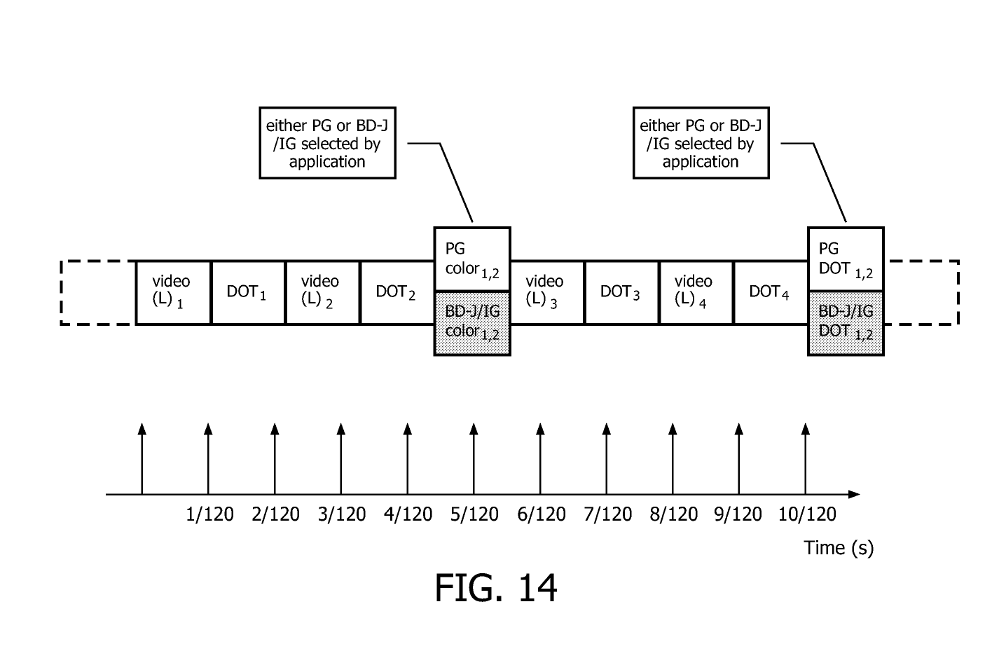

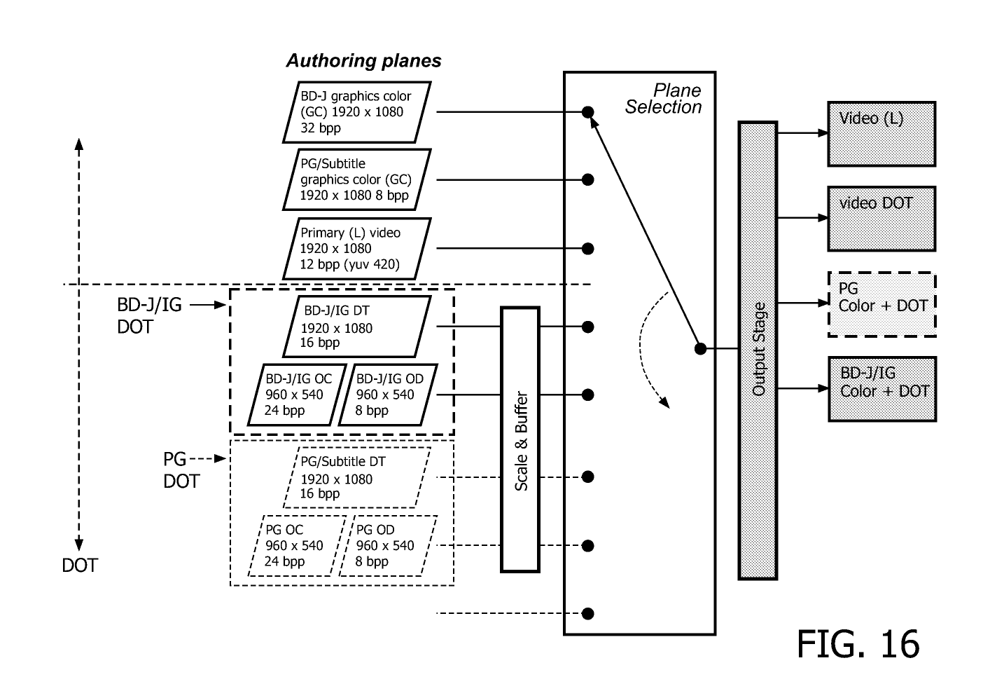

Alternatively, one could chose to sent information with respect to a single plane, so that either PG or BD-J planes are selected by the player device to be sent over the interface is a specific unit. FIG. 14 shows schematically the time output of frames over the video interface, according to the this embodiment of the invention while FIG. 16 shows schematically a processing unit and an output stage according to this embodiment of the invention.

The HDMI interface input of the display device according to this embodiment of the invention is adapted to receive the units of frames as described above with respect to FIGS. 14 and 16, to separate them and sent the information to the compositing stage 18 which takes care of compositing of video planes. The output of the compositing stage is sent to the rendering unit for generating the rendered views.

According to another embodiment of the invention, the playback device is able to query the display device with respect to its interface and compositing abilities, which may be according to one of the three embodiments described above. In such case the playback device adapts its output such that the displaying device is able to process the sent stream.

Alternatively, rendering of all the views could be done in the player/settopbox, as herein all information from both the video layer and the graphics layers is available. When rendering in the player/settopbox all information from all layers is available, so when a scene consists of multiple layers of occluding objects (i.e. video layer and 2 graphics layers on top of that), still high quality rendering can be made for multiple viewpoints of that scene. This option however requires the player to contain rendering algorithms for different displays and therefore the preferred embodiment is sending the information from multiple layers to the display and let the (often display-specific) rendering be done in the display.

Alternatively, the video elementary streams could be sent to the display encoded to save on bandwidth. The advantage of this is that more information can be sent to the display. The video quality is unaffected since application formats, like Blu-ray, already use compressed video elementary streams for storage or transmission. The video decoding is done inside the display while the source functions as a pass through for the video elementary streams. Modern TV's are often already capable to decode video streams due to build in digital TV decoders and network connectivity.

This invention can be summarized as follows: A system of transferring of three dimensional (3D) image data for compositing and displaying is described. The information stream comprising video information and overlay information, the video information comprising at least a 2D video stream and 3D video information for enabling rendering of the video information in 3D, the overlay information comprising at least a 2D overlay stream and 3D overlay information for enabling rendering of the overlay information in 3D. In the system according to the invention, the compositing of video plane takes place in the display device instead of the playback device. The system comprises a playback device adapted for transmitting over the video interface a sequence of frames, the sequence of frames comprising units, each unit corresponding to decompressed video information and decompressed overlay information intended to be composited and displayed as a 3D image, and a display device adapted for receiving over the video interface the sequence of frames and extracting the 3D video information and the 3D overlay information from the units and compositing the units into 3D frames and displaying the 3D frames.

It should be noted that the above-mentioned embodiments are meant to illustrate rather than limit the invention. And that those skilled in the art will be able to design many alternative embodiments without departing from the scope of the appended claims. In the claims, any reference signs placed between parentheses shall not be construed as limiting the claim. Use of the verbs “comprise” and “include” and their conjugations do not exclude the presence of elements or steps other than those stated in a claim. The article “a” or an” preceding an element does not exclude the presence of a plurality of such elements. The invention may be implemented by means of hardware comprising several distinct elements and by means of a suitable programmed computer. A computer program may be stored/distributed on a suitable medium, such as optical storage or supplied together with hardware parts, but may also be distributed in other forms, such as being distributed via the Internet or wired or wireless telecommunication systems. In a system/device/apparatus claim enumerating several means, several of these means may be embodied by one and the same item of hardware or software. The mere fact that certain measures are recited in mutually different dependent claims does not indicate that a combination of these measures cannot be used to advantage.

1. A method of compositing and displaying an information stream comprising video information and overlay information,
the video information comprising at least a 2D video stream and 3D video information for enabling rendering of the video information in 3D,
the overlay information comprising at least a 2D overlay stream and 3D overlay information for enabling rendering of the overlay information in 3D,
the method comprising
receiving or reading from a storage medium a compressed stream comprising compressed video information and compressed overlay information;
decompressing the video information and the overlay information;
transmitting over the video interface a sequence of frames, the sequence of frames comprising units, each unit corresponding to decompressed video information and decompressed overlay information intended to be composited and displayed as a 3D image;
receiving over the video interface the sequence of frames and extracting the 3D video information and the 3D overlay information from the units;
compositing the units into 3D frames and displaying the 3D frames.

2. A method according to claim 1, wherein the 3D video information comprises depth, occlusion and transparency information with respect to 2D video frames, and the 3D overlay information comprises depth, occlusion and transparency information with respect to 2D overlay frames.

3. A method according to claim 2 wherein the overlay information comprises two graphics planes to be composited with the video frames.

4. A method according to claims 2 or 3 wherein overlay information for at least one graphic plane being sent at a lower frame frequency that a frames frequency at which the 2D video frames are sent.

5. A method according to claim 2 wherein a pixel size of the overlay information for at least one graphic plane differs from a pixel size of the 2D video information.

6. A method according to claim 1 wherein 3D video information comprises stereo information.

7. A system for compositing and displaying an information stream comprising video information and overlay information,
the video information comprising at least a 2D video stream and 3D video information for enabling rendering of the video information in 3D,
the overlay information comprising at least a 2D overlay stream and 3D overlay information for enabling rendering of the overlay information in 3D,
the system comprising
a playback device for
receiving or reading from a storage medium a compressed stream comprising compressed video information and compressed overlay information;
decompressing the video information and the overlay information;
transmitting over the video interface a sequence of frames, the sequence of frames comprising units, each unit corresponding to decompressed video information and decompressed overlay information intended to be composited and displayed as a 3D image
and a display device for
receiving over the video interface the sequence of frames and extracting the 3D video information and the 3D overlay information from the units;
compositing the units into 3D frames and displaying the 3D frames.

8. A system according to claim 7, wherein the 3D video information comprises depth, occlusion and transparency information with respect to 2D video frames, and the 3D overlay information comprises depth, occlusion and transparency information with respect to 2D overlay frames.

9. A system according to claim 8, wherein the overlay information comprises two graphics planes to be composited with the video frames.

10. A system according to claim 8, wherein overlay information for at least one graphic plane being sent at a lower frame frequency that a frames frequency at which the 2D video frames are sent.

11. A system according to claim 8, wherein a pixel size of the overlay information for at least one graphic plane differs from a pixel size of the 2D video information.

12. A system according to claim 8, wherein 3D video information comprises stereo information.

13. A system according to claim 8, wherein the frames are RGB frames sent over a HDMI interface.

14. Playback device suitable for use in a system according to claim 8.

15. Display device suitable for use in a system according to claim 8.
